(19) United States
(12) Patent Application Publication
(10) Pub. No.: US 2020/0219024 A1
(43) Pub. Date: Jul. 9, 2020

(54) SYSTEM AND METHOD FOR REAL-TIME BUSINESS INTELLIGENCE ATOP EXISTING STREAMING PIPELINES

(71) Applicant: Walmart Apollo, LLC, Bentonville, AR (US)

(72) Inventor: Andrew Torson, Lafayette, CA (US)

(21) Appl. No.: 16/241,906

(22) Filed: Jan. 7, 2019

(51) Int. Cl. G06Q 10/06; G06F 17/10

(52) U.S. Cl. CPC G06Q 10/0637; G06F 17/10; G06Q 10/06393

(57) ABSTRACT

Systems and methods of generating real-time business intelligence metrics from a data pipeline are disclosed. A data pipeline configured to provide a plurality of events from at least one source to at least one consumer is implemented and a first metric calculator configured to calculate at least one business intelligence metric using one or more metric keys related to a set of the plurality of events is generated. The first metric calculator is attached to the data pipeline using at least one operator provider configured to extract metric keys from the set of the plurality of events. The at least one business intelligence metric is stored in a business intelligence metric database.

### TECHNICAL FIELD

This application relates generally to monitoring of data pipelines and, more particularly, to generating business intelligence from data pipelines.

### BACKGROUND

Monitoring of data pipelines in networked environments, such as e-commerce or other networked environments, is essential for ensuring proper operation and health of the network. Current monitoring systems allow collection of metrics to provide health data for the network, publishing of metrics to a metric database, querying of the database, and presentation of the queried metrics to a user. Current monitoring systems fail to provide the ability to extract business intelligence metrics in real-time.

Current systems obtain pipeline metrics after the pipeline has operated on incoming data and/or events. For example, when calculating the number of events processed, current systems rely on the output of downstream processes to report the number of events that they encountered/processed. Current systems only generate business intelligence in less-than-real-time due to delays between delivery of data in the data pipeline and processing of the data by downstream processes.

### SUMMARY

In various embodiments, a system including a computing device is disclosed. The computing device is configured to implement a data pipeline configured to provide a plurality of events from at least one source to at least one consumer and generate a first metric calculator configured to calculate at least one business intelligence metric using one or more metric keys related to a set of the plurality of events. The computing device is further configured to attach the first metric calculator to the data pipeline using at least one operator provider configured to extract metric keys from the set of the plurality of events and store the at least one business intelligence metric in a business intelligence metric database.

In various embodiments, a non-transitory computer readable medium having instructions stored thereon is disclosed. The instructions, when executed by a processor cause a device to perform operations including implementing a data pipeline including a plurality of events from at least one source to at least one consumer and generating a first metric calculator configured to calculate at least one business intelligence metric using one or more metric keys related to a set of the plurality of events. The first metric calculator is attached to the data pipeline using at least one operator provider configured to extract metric keys from the set of the plurality of events. The at least one business intelligence metric is stored in a business intelligence metric database.

In various embodiments, a method is disclosed. The method includes the steps of implementing a data pipeline including a plurality of events from at least one source to at least one consumer and generating a first metric calculator configured to calculate at least one business intelligence metric using one or more metric keys related to a set of the plurality of events. The first metric calculator is attached to the data pipeline using at least one operator provider configured to extract metric keys from the set of the plurality of events. The at least one business intelligence metric is stored in a business intelligence metric database.

### BRIEF DESCRIPTION OF THE DRAWINGS

The features and advantages will be more fully disclosed in, or rendered obvious by the following detailed description of the disclosed embodiments, which are to be considered together with the accompanying drawings wherein like numbers refer to like parts and wherein:

FIG. 1 illustrates a block diagram of a computer system, in accordance with some embodiments.

FIG. 2 illustrates a network configured to provide real-time business intelligence from a data pipeline, in accordance with some embodiments.

FIG. 3 illustrates a method of business intelligence generation from a data pipeline, in accordance with some embodiments.

FIG. 4 illustrates a system flow of various system elements during the execution of the method of FIG. 3, in accordance with some embodiments.

FIG. 5 illustrates a hierarchical generation process for one or more metric calculators and/or operational providers, in accordance with some embodiments.

### DETAILED DESCRIPTION

The ensuing description provides preferred exemplary embodiment(s) only and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes can be made in the function and arrangement of elements without departing from the spirit and scope as set forth in the appended claims.

In various embodiments, systems and methods of generating real-time business intelligence metrics from a data pipeline are disclosed. A data pipeline is configured to provide a plurality of events from at least one source to at least one consumer. A first metric calculator is configured to calculate at least one business intelligence metric using one or more metric keys related to a set of the plurality of events is generated and is attached to the data pipeline using at least one operator provider configured to extract metric keys from the set of the plurality of events. The at least one business intelligence metric is stored in a business intelligence metric database.

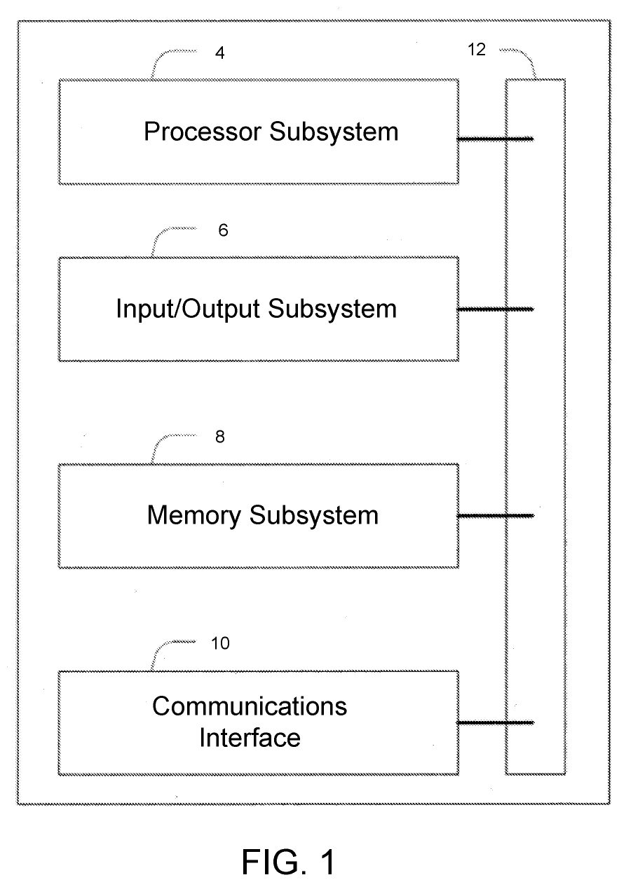

FIG. 1 illustrates a computer system configured to implement one or more processes, in accordance with some embodiments. The system 2 is a representative device and may comprise a processor subsystem 4, an input/output subsystem 6, a memory subsystem 8, a communications interface 10, and a system bus 12. In some embodiments, one or more than one of the system 2 components may be combined or omitted such as, for example, not including an input/output subsystem 6. In some embodiments, the system 2 may comprise other components not combined or comprised in those shown in FIG. 1. For example, the system 2 may also include, for example, a power subsystem. In other embodiments, the system 2 may include several instances of the components shown in FIG. 1. For example, the system 2 may include multiple memory subsystems 8. For the sake of conciseness and clarity, and not limitation, one of each of the components is shown in FIG. 1.

The processor subsystem 4 may include any processing circuitry operative to control the operations and performance of the system 2. In various aspects, the processor subsystem 4 may be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also may be implemented by a controller, a microcontroller, an application specific integrated circuit (ASIC), a field programmable gate array (FPGA), a programmable logic device (PLD), and so forth.

In various aspects, the processor subsystem 4 may be arranged to run an operating system (OS) and various applications. Examples of an OS comprise, for example, operating systems generally known under the trade name of Apple OS, Microsoft Windows OS, Android OS, Linux OS, and any other proprietary or open source OS. Examples of applications comprise, for example, network applications, local applications, data input/output applications, user interaction applications, etc.

In some embodiments, the system 2 may comprise a system bus 12 that couples various system components including the processing subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 may include any suitable mechanism or component to enable a user to provide input to system 2 and the system 2 to provide output to the user. For example, the input/output subsystem 6 may include any suitable input mechanism, including but not limited to, a button, keypad, keyboard, click wheel, touch screen, motion sensor, microphone, camera, etc.

In some embodiments, the input/output subsystem 6 may include a visual peripheral output device for providing a display visible to the user. For example, the visual peripheral output device may include a screen such as, for example, a Liquid Crystal Display (LCD) screen. As another example, the visual peripheral output device may include a movable display or projecting system for providing a display of content on a surface remote from the system 2. In some embodiments, the visual peripheral output device can include a coder/decoder, also known as Codecs, to convert digital media data into analog signals. For example, the visual peripheral output device may include video Codecs, audio Codecs, or any other suitable type of Codec.

The visual peripheral output device may include display drivers, circuitry for driving display drivers, or both. The visual peripheral output device may be operative to display content under the direction of the processor subsystem 6. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 may include any suitable hardware, software, or combination of hardware and software that is capable of coupling the system 2 to one or more networks and/or additional devices. The communications interface 10 may be arranged to operate with any suitable technique for controlling information signals using a desired set of communications protocols, services or operating procedures. The communications interface 10 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 may comprise a wireless interface comprising one or more antennas, transmitters, receivers, transceivers, amplifiers, filters, control logic, and so forth.

In various aspects, the communications interface 10 may provide data communications functionality in accordance with a number of protocols. Examples of protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 may comprise any machine-readable or computer-readable media capable of storing data, including both volatile/non-volatile memory and removable/non-removable memory. The memory subsystem 8 may comprise at least one non-volatile memory unit. The non-volatile memory unit is capable of storing one or more software programs. The software programs may contain, for example, applications, user data, device data, and/or configuration data, or combinations therefore, to name only a few. The software programs may contain instructions executable by the various components of the system 2.

In various aspects, the memory subsystem 8 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 may contain an instruction set, in the form of a file for executing various methods, such as methods including A/B testing and cache optimization, as described herein. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 4.

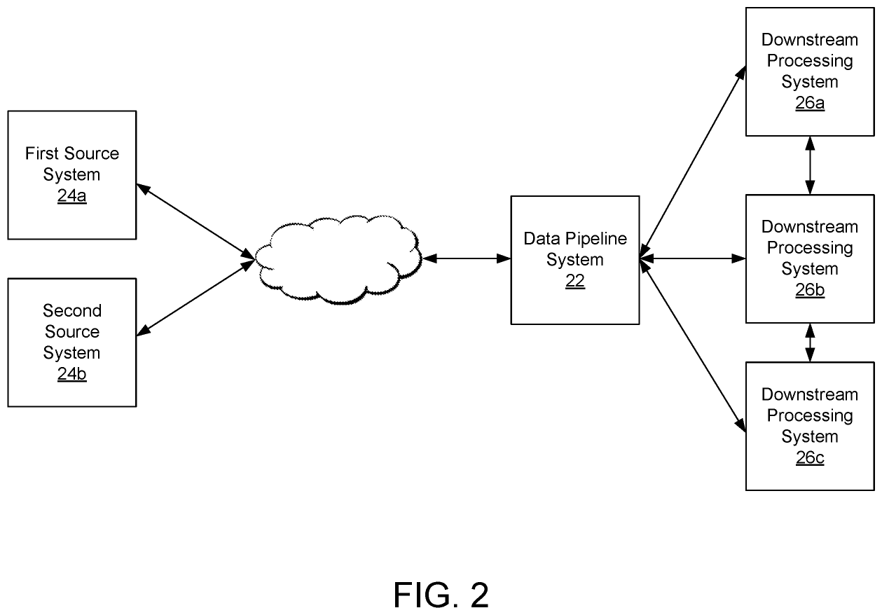

FIG. 2 illustrates a network 20 including a data pipeline system 22, a first source system 24a, a second source system 24b, and a plurality of data processing systems 26a-26c. Each of the systems 22-26c can include a system 2 as described above with respect to FIG. 1, and similar description is not repeated herein. Although the systems are each illustrated as independent systems, it will be appreciated that each of the systems may be combined, separated, and/or integrated into one or more additional systems. For example, in some embodiments, the data ingestion system 22, and at least one data processing system 26a may be implemented by a shared server or shared network system. Similarly, the data source systems 24a, 24b may be integrated into additional systems, such as networked systems or servers.

In some embodiments, the data pipeline system 22 is configured to provide a network interface to the source systems 24a-24b. For example, in some embodiments, the data pipeline system 22 is configured to provide a data ingestion frontend for receiving data input from one or more data source systems 24a, 24b. As one example, in some embodiments, the data ingestion system 22 is configured to provide distributed cache configured to receive and store each event generated by a data source system 24a, 24b, although it will be appreciated that the disclosed systems and methods can be applied to any suitable systems.

In some embodiments, each of the data sources 24a-24b are configured to generate a data stream of events for processing by one or more of the data processing systems 26a-26c. For example, in some embodiments, each of the data sources 24a-24c is configured to generate a continuous stream of events configured to update and/or provide information regarding products in an e-commerce catalog. Although specific embodiments are discussed herein, it will be appreciated that the disclosed systems and methods can be applied to any suitable data pipeline system configured to ingest and process events related to any catalog of items.

In some embodiments, and as discussed in greater detail below, the data pipeline system 22 is configured to provide real-time metrics related to one or more business intelligence tasks. In some embodiments, the data pipeline system 22 is configured to provide business intelligence and/or key performance indicators (KPIs). One or more metric collection calculators are defined and linked to (e.g., hooked to) the data pipeline. In some embodiments, the data pipeline system 22 is configured to provide metric collection calculators including, but not limited to, KPI calculators related to meet/beat scores, stop-loss categories, and/or other KPIs, top-K counters (e.g., top-10, top-20, etc.), anomaly detection (e.g., stateful outlier input detectors, categorized tail statistics, or other anomaly detection), price strategy KPIs (e.g., item-level descriptive/prescriptive time-window snapshots), and/or any other suitable business intelligence metrics.

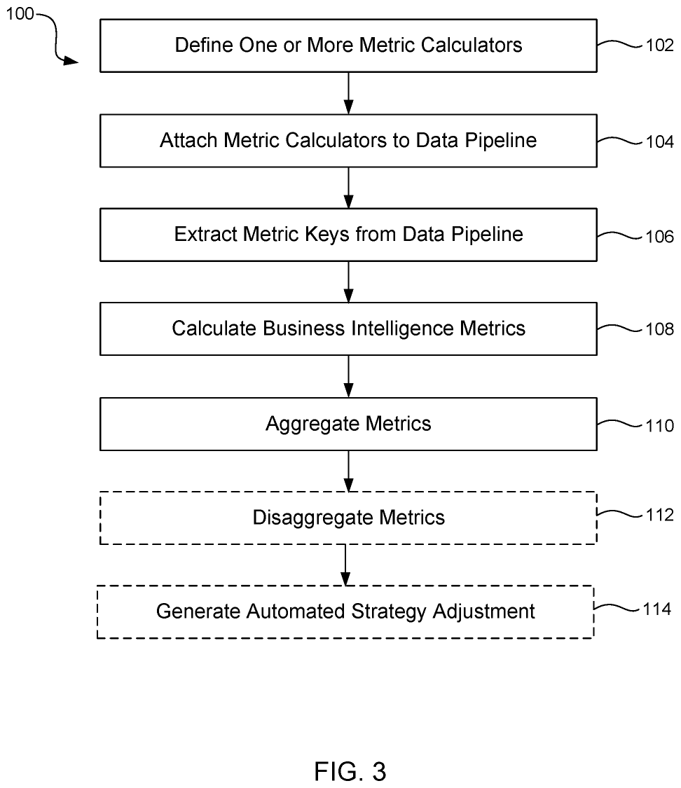

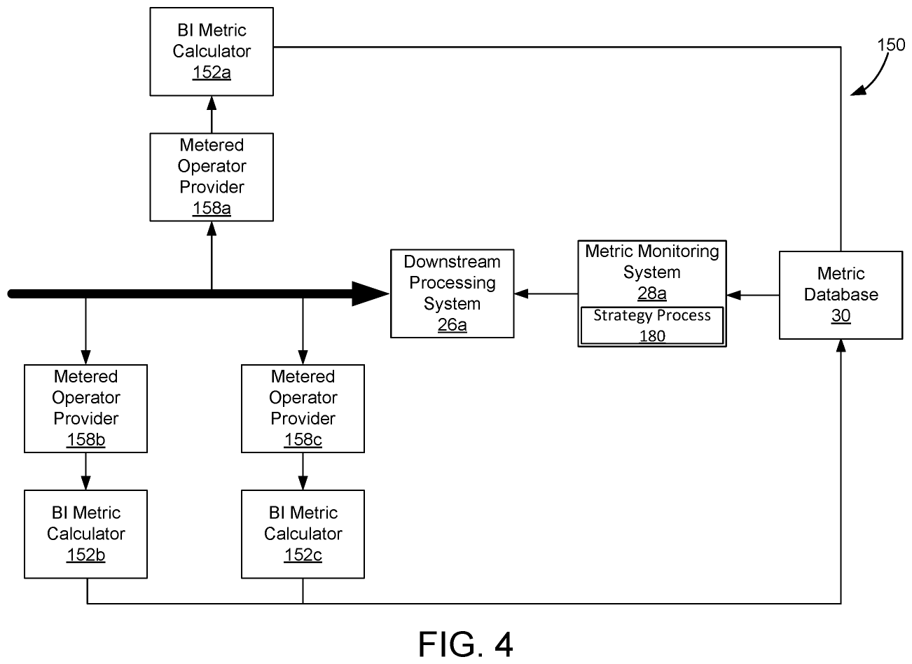

FIG. 3 illustrates a method 100 of generating and presenting business intelligence metrics from a data pipeline in real-time, in accordance with some embodiments. FIG. 4 illustrates a system flow 150 of various system elements during the method 100, in accordance with some embodiments. At step 102, one or more metric calculators 152a-152c are defined. The metric calculators 152a-152c can be configured to collect and calculate any suitable business intelligence metrics. For example, in various embodiments one or more KPIs, top-K counters, anomaly detection calculators, item-level descriptive and/or prescriptive time-window snapshot KPIs, and/or any other suitable calculators can be defined.

In some embodiments, KPI calculators are configured to generate aggregate data metrics based on one or more data elements extracted from the data pipeline 154. Examples of business metric KPIs implemented as a metric calculator 152a-152c can include, but are not limited to, meet/beat scores, stop-loss categories, item counters (e.g., counter for number of items with price above threshold, count by number I.D., etc.) and/or other suitable KPI calculators. The KPI calculators are configured to aggregate a large number (i.e., millions/billions) of data points for use in business intelligence metric monitoring. The KPI calculators are configured to provide up-to-date and valid results as of the time a query (e.g., a request for the metric) is submitted.

In some embodiments, a top-K calculator is configured to provide a set of K items that score at one of a top and/or bottom end of a calculated metric. For example, in some embodiments, top-K calculators can include, but are not limited to, the top-K revenue generating items, the top-K items with abnormal value of price, top-K items in inventory, etc. The variable K can be any suitable number of elements, such as, for example, 10, 20, 50, 100, etc.

In some embodiments, an anomaly detection calculator is configured to identify, or calculate, outlier items. For example, in some embodiments, anomaly detection calculators include, but are not limited to, stateful outlier input detectors, categorized tail statistics, etc. The anomaly detection calculators can include any suitable anomaly detection criteria defined during calculator creation, as discussed in greater detail below.

In some embodiments, the one or more metric calculators 152a-152c are defined based on a hierarchical set of stateful calculators. A set of metric calculators can be defined including predetermined metric categories, such as, for example, scalar metric calculators and/or vector metric calculators. If a new metric is required, one of the scalar metric calculators or the vector metric calculators can be extended and defined to extract the required data from the pipeline and calculate the requested metric. In one example, a new metric related to price changes of items in the e-commerce catalog may be defined as an extension of a vector metric calculator. The price change metric is configured to extract item price data, such as item price change data or current item price data.

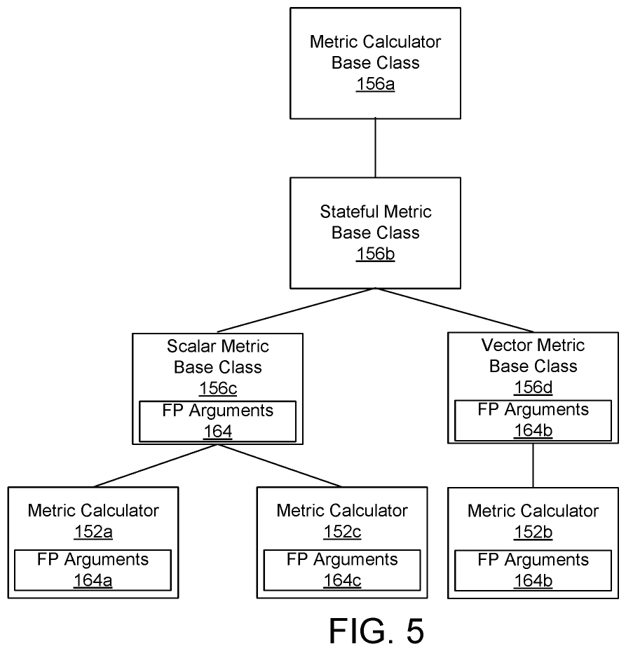

As shown in FIG. 5, in embodiments, each new metric is defined from a preexisting metric class 156a-156d using one or more functional programming (FP) arguments 164 (e.g., FP lambda arguments). For example, in some embodiments, a plurality of metric calculator base classes 156a-156d define common or shared elements across a predetermined category of business intelligence metric calculators. In the illustrated embodiment, a metric calculator base class 156a includes functionality shared by all business intelligence metrics configured for the data pipeline 154. A stateful metric base class 156b extends the metric base class 156a to include shared functionality of stateful metrics. The stateful metric base class 156b is further extended by each of a scalar metric base class 156c and a vector metric base class 156d, which may each be further extended to define a specific metric calculator 152a-152c, for example, by defining one or more FP arguments 164 maintained in the scalar metric base class 156c or the vector metric base class 156d.

As one example, a metric calculator 152c for determining the number of items priced above a certain threshold is defined. In order to determine the requested metric, a metric calculator 152c must be configured to obtain a price attribute of each item in the data pipeline 154, compare the price attribute to a threshold, and provide a count of the number of items with price attributes above a predetermined threshold. The metric calculator 152c is generated by extending the scalar metric base class 156c by defining a set of required FP arguments 164, such as, FP arguments for at least one target attribute and a threshold. Because the new metric calculator 152c extends from the scalar metric base class 156c, the methods and processes for attaching to the data pipeline 154, generating a comparison between the item price and the predetermined threshold, and outputting the count are predefined in the parent scalar metric base class 156c and do not have to be redefined for each new metric calculator 152a, 152c depending from the scalar metric base class 156c.

At step 104, each of the defined metric calculators 152a-152c are attached to the data pipeline 154 (e.g., the data pipeline 154 is “decorated” with the metric calculators 152a-152c) using one or more metered operator providers 158a-158c. Each metric calculator 152a-152c can be coupled to the data pipeline 154 using a predetermined attachment (or decoration) mechanism, such as, for example, a metered operator provider 158a-158c maintained by the pipeline system 22. In some embodiments, the metered operator providers 158a-158c share a similar hierarchical structure as the metric calculators 152a-152d. In some embodiments, a plurality of base operator providers are defined. For example, in the illustrated embodiment, a base operator provider includes one or more common attachment functions. A set of sub metered operator providers and extend the base operator provider. Each of the sub metered operator providers are further extended to provide a set of operator providers 158a-158c configured to attach one or more metric calculators 152a-152c to the data pipeline 154 (e.g., decorate the data pipeline 154 with the one or more metric calculators 152a-152c). The set of operator providers 158a-158c can include, but is not limited to, a source operator provider 158a, a sink operator provider 158b, and/or a map operator provider 158c.

In some embodiments, steps 102 and 104 allow users to quickly and easily define new business intelligence metrics. For example, in some embodiments, a user can define a new business intelligence metric by selecting an existing base metric calculator 156c, 156d and defining a set of FP lambda arguments for the selected business metric. After defining the FP lambda arguments, the new metric is generated and attached to the data pipeline 154 using an operator provider 158a-158c. In some embodiments, an existing operator provider 158a-158c is selected and/or a new operator provider 158a-158c is defined based on one or more classes in the class hierarchy of the defined metric calculator without user input. For example, in some embodiments, each of the preexisting operator providers 158a 158c can include similar FP arguments as those provided to the metric calculators 152a-152c that allow variants of each of the preexisting operator providers 158a-158c to be generated and attached to the data pipeline 154 by the data pipeline system 22.

At step 106, the operator providers 158a-158c decorating the data pipeline 154 extract a set of metric keys from the data pipeline 104 and provide the metric keys to one or more of the metric calculators 152a-152c. In some embodiments, the extracted metric keys are defined by the operator providers 158a-158c and the individual metric calculators 152a-152c are coupled to operator providers 158a-158c configured to provide a required metric key. In other embodiments, the operator providers 158a-158c are defined based on the metric keys required by the metric calculators 152a-152c.

At step 108, the metric calculators 152a-152c each calculate the requested metrics and generate a metric output that is provided to a metric monitoring system 28a and/or a metric database 30 configured to receive the defined metric from the metric calculator 152a-152c. For example, in some embodiments, a metric calculator 152a configured to generate a multi-dimensional KPI aggregates the key metric and stores the aggregated value (or metric) in the metric database 30. As another example, in some embodiments, a metric calculator 152b configured to calculate a top-K metric calculates scores for each item in the data pipeline 154 and outputs the top-K items identified by the calculation. The top-K items may be stored in a metric database 30.

As discussed above, the KPI metrics calculated using the metric calculators 152a-152c can include multi-dimensional KPI results. In some embodiments, the metric output for business intelligence metrics can include a hypercube defining multiple dimensions of data (e.g., n-dimensions of data). The hypercube is configured to provide a snapshot of the business intelligence metric defined by a selected metric calculator 152a-152c. In some embodiments, the business intelligence metrics are generated and reported without aggregation as regular metric groups, which may cause significant increase in memory usage by a hypercube for the defined business intelligence metric. For example, in some embodiments, a hypercube for a single KPI metric can include billions (e.g., 10\hat{ }9) data entries arranged in multiple dimensions.

In some embodiments, the dimensions of a hypercube are extracted from the metric data generated by the metric calculator 152a. Each defined metric calculator 152a includes one or more rules for extracting and/or defining hypercube dimensions based on the generated metric data, such as a rule for identifying key extractors, e.g., key terms for extraction. For example, a metric calculator 152a can include a rule configured to extract an item identifier as a first dimension. The metric calculator 152a can identify and extract item identifiers from new items as they are added to the pipeline 154 without needing to be redefined each time a new item is added.

At step 110, one or more metrics are aggregated from the metric database 30 and presented to a user. The aggregated metrics are generated in real-time by pulling up-to-date data from the metric database 30 each time a request or query is generated by a user. The aggregated metrics can be generated and presented to a user using known metric aggregation processes. At optional step 112, one or more aggregated metrics can be disaggregated (or drilled-down) to provide additional context and/or information. When disaggregation is requested, the metric database 30 is queried and new, up-to-date metrics are provided for the disaggregated metric requests.

In some embodiments, aggregation of metrics may be provided by a time-series database, such as, for example, an open source time-series database. The metric data extracted from the data pipeline 154 may be stored in a time-series database and organized according to any suitable organization scheme. Aggregation may be done via one or more predetermined aggregation methods, such as, for example, a summation method, an average method, a count method, a percentile method, and/or any other suitable method for one or more identified groups. In some embodiments, disaggregation of metrics may be provided by one or more front-end clients configured to generate granular aggregation queries within the aggregated data within a specific dimension. In some embodiments, disaggregation is provided by an open source disaggregation dashboard.

At optional step 114, one or more automated strategy adjustment processes 180 are executed to generate adjustments to one or more catalog items based on one or more business intelligence metrics generated by the metric calculators 152a-152c. The automated strategy adjustments 180 are configured to adjust one or more parameters (or elements) of one or more items in a catalog. For example, in some embodiments, an automated strategy process 180 includes a price strategy selection process configured to retrieve one or more business intelligence metrics related to pricing of items, such as, for example, current price of items in the data pipeline 154, competitor pricing information, etc. The price strategy selection process includes one or more rules configured to identify when a pricing change to an item should be generated. For example, if one or more metrics generated by one or more metric calculators 152a-152c indicate that a current price of an item is different than a competitor price for the same item by a predetermined amount, the price strategy selection process changes the price of the item. Although a price strategy selection process is illustrates, it will be appreciated that any automated strategy adjustment can be implemented based on one or more metrics generated by one or more metric calculators 152a-152c.

In various embodiments, the systems and methods disclosed herein can be implemented in one or more existing pipelines or pipeline analytic engines, such as, for example, Flink, Spark, JRPC, etc. The disclosed systems and methods enable business intelligence metrics to be generated, stored, and accessed in real-time directly from a data pipeline.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising
a computing device configured to:
implement a data pipeline configured to provide a plurality of events from at least one source to at least one consumer;
generate a first metric calculator configured to calculate at least one business intelligence metric using one or more metric keys related to a set of the plurality of events;
attach the first metric calculator to the data pipeline using at least one operator provider, wherein the operator provider is configured to extract metric keys from the set of the plurality of events; and
store the at least one business intelligence metric in a business intelligence metric database.

2. The system of claim 1, wherein the first metric calculator is generated by extending at least one base metric calculator to define the first metric calculator.

3. The system of claim 2, wherein the at least one base metric calculator is extended by defining one or more functional programming arguments maintained by the at least one base metric calculator.

4. The system of claim 1, wherein the at least one operator provider is generated by extending at least one base operator provider to define the at least one operator provider.

5. The system of claim 1, wherein the computing device is configured to:
define at least one functional programming argument, wherein the first metric calculator is generated by extending at least one base metric calculator based on the at least one functional programming argument, and wherein the at least one operator provider is generated by extending at least one base operator provider to define the at least one operator provider based on the at least one functional programming argument.

6. The system of claim 1, wherein the computing device is configured to:
retrieve the at least one business intelligence metric from the business intelligence metric database;
provide the at least one business intelligence metric to a metric monitoring process configured to implement at least one automated strategy adjustment rule; and
update at least one item in a catalog of items based on the automated strategy adjustment rule.

7. The system of claim 1, wherein the computing device is configured to:
receive a request for at least one aggregated business intelligence metric;
retrieve each business intelligence metric included in the at least one aggregated business intelligence metric from the business intelligence metric database; and
provide the at least one aggregated business intelligence metric to a metric monitoring process configured to generate a visual output representative of the aggregated business intelligence metric.

8. The system of claim 7, wherein the computing device is configured to:
receive a request to expand a first dimension of the aggregated business intelligence metric;
retrieve an updated business intelligence metric corresponding to the first dimension of the aggregated business intelligence metric from the metric database, wherein the updated business intelligence metric includes a metric calculation generated after the aggregated business intelligence metric is provided to the metric monitoring process; and
provide the updated metric to the metric monitoring process.

9. The system of claim 7, wherein the aggregated business intelligence metric is a hypercube.

10. The system of claim 1, wherein the at least one business intelligence metric comprises at least one of a key performance indicators (KPI) calculator, a top-k counter, or an anomaly detection calculator.

11. A non-transitory computer readable medium having instructions stored thereon, wherein the instructions, when executed by a processor cause a device to perform operations comprising:
implementing a data pipeline including a plurality of events from at least one source to at least one consumer;
generating a first metric calculator configured to calculate at least one business intelligence metric using one or more metric keys related to a set of the plurality of events;
attaching the first metric calculator to the data pipeline using at least one operator provider, wherein the operator provider is configured to extract metric keys from the set of the plurality of events; and
storing the at least one business intelligence metric in a business intelligence metric database.

12. The non-transitory computer readable medium of claim 11, wherein the first metric calculator is generated by extending at least one base metric calculator to define the first metric calculator.

13. The non-transitory computer readable medium of claim 12, wherein the at least one base metric calculator is extended by defining one or more functional programming arguments maintained by the at least one base metric calculator.

14. The non-transitory computer readable medium of claim 11, wherein the at least one operator provider is generated by extending at least one base operator provider to define the at least one operator provider.

15. The non-transitory computer readable medium of claim 11, wherein the instructions, when executed by the processor cause the device to perform further operations comprising:
defining at least one functional programming argument, wherein the first metric calculator is generated by extending at least one base metric calculator based on the at least one functional programming argument, and wherein the at least one operator provider is generated by extending at least one base operator provider to define the at least one operator provider based on the at least one functional programming argument.

16. The non-transitory computer readable medium of claim 11, wherein the instructions, when executed by the processor cause the device to perform further operations comprising:
retrieving the at least one business intelligence metric from the business intelligence metric database;
providing the at least one business intelligence metric to a metric monitoring process configured to implement at least one automated strategy adjustment rule; and
updating at least one item in a catalog of items based on the automated strategy adjustment rule.

17. The non-transitory computer readable medium of claim 11, wherein the instructions, when executed by the processor cause the device to perform further operations comprising:
receiving a request for at least one aggregated business intelligence metric;
retrieving each business intelligence metric included in the at least one aggregated business intelligence metric from the business intelligence metric database, wherein the at least one aggregated business intelligence metric is a hypercube; and
providing the at least one aggregated business intelligence metric to a metric monitoring process configured to generate a visual output representative of the aggregated business intelligence metric.

18. The non-transitory computer readable medium of claim 17, wherein the instructions, when executed by the processor cause the device to perform further operations comprising:
receiving a request to expand a first dimension of the aggregated business intelligence metric;
retrieving an updated business intelligence metric corresponding to the first dimension of the aggregated business intelligence metric from the metric database, wherein the updated business intelligence metric includes a metric calculation generated after the aggregated business intelligence metric is provided to the metric monitoring process; and
providing the updated metric to the metric monitoring process.

19. A method, comprising:
implementing a data pipeline including a plurality of events from at least one source to at least one consumer;
generating a first metric calculator configured to calculate at least one business intelligence metric using one or more metric keys related to a set of the plurality of events;
attaching the first metric calculator to the data pipeline using at least one operator provider, wherein the operator provider is configured to extract metric keys from the set of the plurality of events; and
storing the at least one business intelligence metric in a business intelligence metric database.

20. The method of claim 19, comprising defining at least one functional programming argument, wherein the first metric calculator is generated by extending at least one base metric calculator based on the at least one functional programming argument, and wherein the at least one operator provider is generated by extending at least one base operator provider to define the at least one operator provider based on the at least one functional programming argument.
